(19) United States
(12) Patent Application Publication
(10) Pub. No.: US 2020/0233237 A1
(43) Pub. Date: Jul. 23, 2020

(54) Attachment Structure for Front Hanging Eyeglasses

(71) Applicant: Wen-Tse Huang, Kaohsiung City (TW)

(72) Inventor: Wen-Tse Huang, Kaohsiung City (TW)

(21) Appl. No.: 16/251,181

(22) Filed: Jan. 18, 2019

(51) Int. Cl. G02C 9/04; G02C 7/08; G02C 7/12; G02C 7/10

(52) U.S. Cl. CPC G02C 9/04; G02C 7/086; G02C 2200/02; G02C 7/10; G02C 7/12

(57) ABSTRACT

An attachment structure for front hanging eyeglasses includes a pair of main eyeglasses, at least one magnetic socket, and a pair of front hanging eyeglasses. The magnetic socket is detachably combined on the main eyeglasses and provided with a first magnet. The front hanging eyeglasses includes an auxiliary eyeglass, a support device, and at least one magnetic connector. The support device includes two supporting portions detachably combined on the main eyeglasses. A shaft is connected between the supporting portions, and a rotary tube is rotatably mounted around the shaft and engaged with the auxiliary eyeglass, so that the auxiliary eyeglass is pivotally rotated about the shaft. The magnetic connector is mounted on the support device and has a second magnet with which the first magnet is engaged, so that the front hanging eyeglasses can be securely hung in the front of the main eyeglasses.

### BACKGROUND OF THE INVENTION

### 1. Field of the Invention

The present invention relates to an attachment structure for front hanging eyeglasses and, more particularly, to a pair of front hanging eyeglasses which is adapted to be hung in front of the spectacle frame of a pair of ordinary eyeglasses and can be lifted upward relative to the spectacle frame.

### 2. Description of the Related Art

Because visual deterioration is common in people who are getting old, a person wearing myopic lenses usually prepares another pair of reading eyeglasses for unexpected needs. Moreover, a person who stays at dazzling outside environment has to wear a pair of polarizers or sunglasses to protect his/her eyes. However, a user who prepares multiple pairs of eyeglasses simultaneously may feel inconvenient. Accordingly, the so-called front hanging glasses assembly has been created for users who prefer not to bring multiple pairs of eyeglasses simultaneously.

A front hanging glasses assembly includes a pair of main eyeglasses and a pair of auxiliary front hanging eyeglasses which can be attached to or removed from the pair of main eyeglasses. The pair of front hanging eyeglasses works as functional lenses, for example, sunglasses or polarizers mostly. A user staying outside and dazzled by fierce sunlight could wear the pair of front hanging eyeglasses in front of the pair of main eyeglasses to filter excessive sunlight without wearing another pair of eyeglasses. With additional functions, the pair of front hanging eyeglasses offers benefits over the pair of main eyeglasses. A user feels free to hang the pair of front hanging eyeglasses in the front of the pair of main eyeglasses but needs not to replace the pair of main eyeglasses by another pair. However, it is not convenient for a user to handle a pair of front hanging eyeglasses attached on or detached from a pair of main eyeglasses frequently.

### BRIEF SUMMARY OF THE INVENTION

Thus, an objective of the present invention is to provide an attachment structure for a pair of front hanging eyeglasses which is easily hung on a pair of main eyeglasses and can be flexibly and conveniently adjusted for an angle between the pair of front hanging eyeglasses and the pair of main eyeglasses as required with no need for removal of the pair of front hanging eyeglasses that is not used.

To achieve this and other objectives, an attachment structure for front hanging eyeglasses of the present invention includes a pair of main eyeglasses, at least one magnetic socket, and a pair of front hanging eyeglasses. The pair of main eyeglasses includes a spectacle frame. The magnetic socket is mounted on the spectacle frame and provided with at least one first magnet. The pair of front hanging eyeglasses includes an auxiliary eyeglass, a support device, and at least one magnetic connector. The support device includes two supporting portions, a shaft connected between the two supporting portions, and a rotary tube rotatably mounted around the shaft and engaged with the auxiliary eyeglass. The supporting portions are combined on the spectacle frame. The magnetic connector is combined with the support device and provided with at least one second magnet which connects with the first magnet magnetically. The auxiliary eyeglass is pivotally rotated about the shaft of the support device and can be positioned at multiple locations.

In an embodiment, the shaft has at least one positioning portion provided with a plurality of first teeth. At least one longitudinal end of the rotary tube is provided with a plurality of second teeth engaged with the first teeth. The auxiliary eyeglass can be positioned at the multiple locations by the combination of the first and second teeth when rotating about the shaft of the support device.

In an embodiment, the spectacle frame includes an upper portion having a bridge at the center thereof, and a top of the magnetic socket is provided with a snap-fit portion which is detachably combined on the bridge of the spectacle frame.

In an embodiment, the shaft is provided with two spaced positioning portions, and the rotary tube is located between the positioning portions. Two spaced connection pins are provided on the magnetic connector and respectively connected to the positioning portions.

In an embodiment, the upper portion of the spectacle frame has two lateral edges. The at least one magnetic socket includes two magnetic sockets, and a top of each of the magnetic sockets is provided with a snap-fit portion which is detachably combined on one of the lateral edges of the spectacle frame. The at least one magnetic connector includes two magnetic connectors which are formed at outer ends of the two supporting portions, respectively.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is an exploded, schematic view of an attachment structure for front hanging eyeglasses according to an embodiment of the present invention.

FIG. 2 is a partial, cross-sectional, schematic view of a pair of front hanging eyeglasses in FIG. 1.

FIG. 3 is an enlarged view of a circled portion of FIG. 2.

FIG. 4 is a schematic view which illustrates the pair front hanging eyeglasses combined with a pair of main eyeglasses in FIG. 1.

FIG. 5 is a schematic view which illustrates the pair of front hanging eyeglasses in FIG. 4 lifted from the pair of main eyeglasses.

FIG. 6 is an exploded, schematic view of an attachment structure for front hanging eyeglasses according to another embodiment of the present invention.

FIG. 7 is a schematic view which illustrates a pair of front hanging eyeglasses combined with a pair of main eyeglasses in FIG. 6.

### DETAILED DESCRIPTION OF THE INVENTION

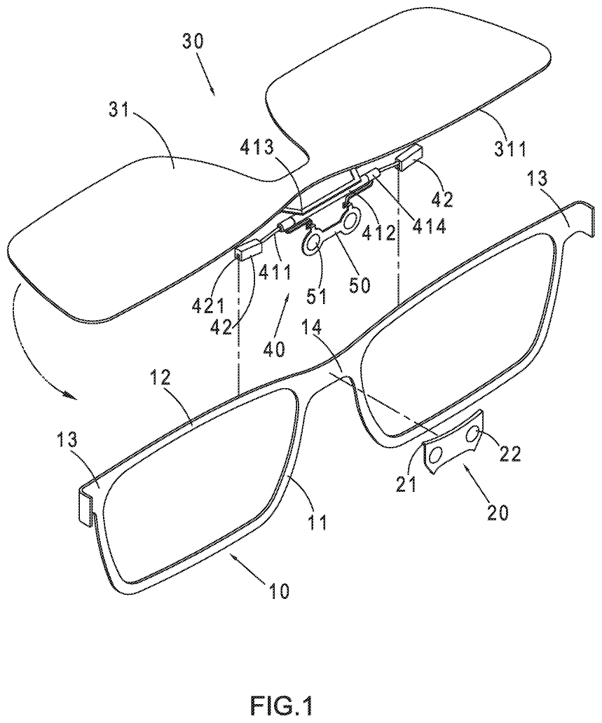

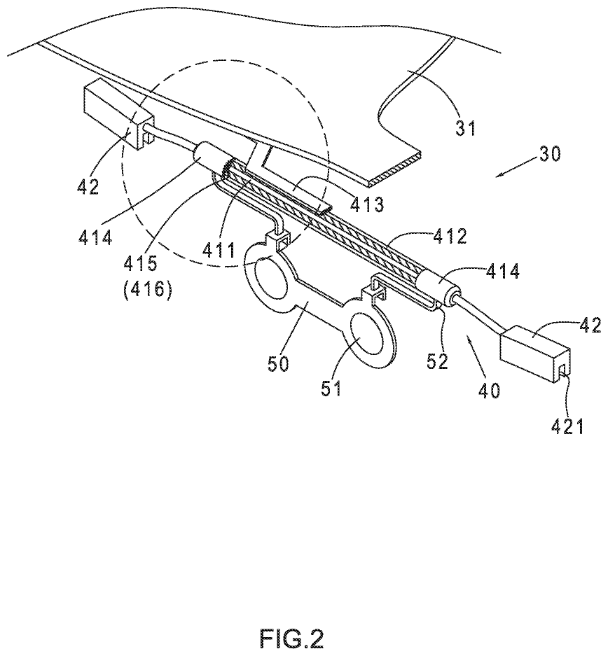

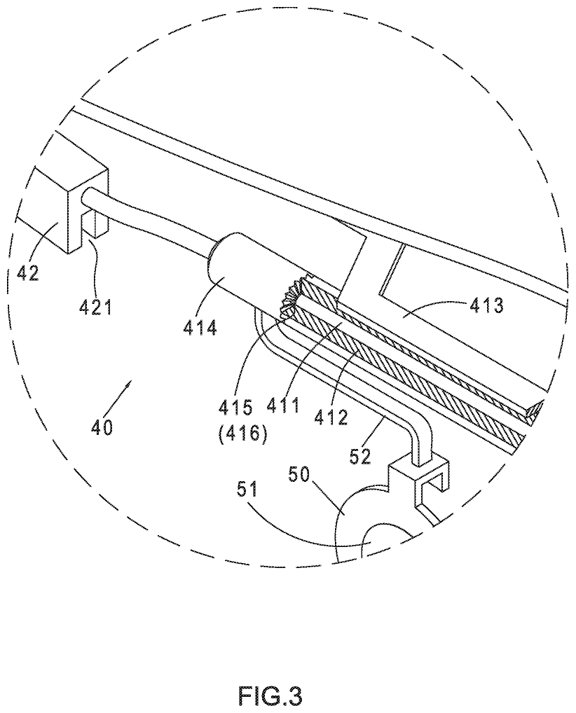

An attachment structure for front hanging eyeglasses according to a first embodiment of the present invention is shown in FIGS. 1 through 4 of the drawings and generally includes a pair of main eyeglasses 10, a magnetic socket 20, and a pair of front hanging eyeglasses 30. The front hanging eyeglasses 30 is easily hung in front of the pair of main eyeglasses 10, so that the pair of main eyeglasses 10 has auxiliary function like a pair of sunglasses, polarizers or reading glasses.

The pair of main eyeglasses 10 includes a spectacle frame 11 having an upper portion 12. The upper portion 12 includes two lateral edges 13 and a bridge 14 at the center thereof. The magnetic socket 20 is detachably combined on the spectacle frame 11. In this embodiment, the magnetic socket 20 has a snap-fit portion 21 at the top thereof which can be combined with or removed from the bridge 14 of the spectacle frame 11. The magnetic socket 20 is provided with at least one first magnet 22 at one side thereof. In this embodiment, the magnetic socket 20 is provided with two spaced first magnets 22 for combining with the pair of front hanging eyeglasses 30.

The pair of front hanging eyeglasses 30 includes an auxiliary eyeglass (a pair of eyeglasses without temples) 31, a support device 40, and a magnetic connector 50. The auxiliary eyeglass 31 can be a pair of sunglasses, polarized lenses, or reading glasses, etc. The support device 40 includes two supporting portions 42, a shaft 411 connected between the supporting portions 42, and a rotary tube 412 engaged with the auxiliary eyeglass 31. The supporting portions 42 are detachably combined on the spectacle frame 11. In this embodiment, a connecting slot 421 is provided in a bottom of each supporting portion 42 for combining on the upper portion 12 of the spectacle frame 11. The shaft 411 is provided with at least one positioning portion 414. In this embodiment, the shaft 411 includes two spaced positioning portions 414. Each positioning portion 414 is a cylindrical tube, and an inner end of at least one positioning portion 414 is provided with a plurality of first teeth 415.

The rotary tube 412 is rotatably mounted around the shaft 411 and provided with an eyeglass holder 413 externally for combination with the auxiliary eyeglass 31, so that the auxiliary eyeglass 31 is pivotally rotated about the shaft 411 of the support device 40 and kept at a desired position relative to the pair of main eyeglasses 10. In this embodiment, the eyeglass holder 413 is mounted at the center of an upper edge 311 of the auxiliary eyeglass 31. The rotary tube 412 is located between the positioning portions 414 and includes a plurality of second teeth 416 on at least one longitudinal end thereof. The second teeth 416 are engaged with the first teeth 415, so that the auxiliary eyeglass 31 can be positioned at multiple locations by the combination of the first and second teeth 415, 416 when rotating about the shaft 411 of the support device.

The magnetic connector 50 is combined with the support device 40. In this embodiment, two spaced connection pins 52 are provided on an upper portion of the magnetic connector 50 and respectively connected to bottoms of the positioning portions 414. When the supporting portions 42 are engaged on the spectacle frame 11, the magnetic connector 50 is opposite to the magnetic socket 20. The magnetic connector 50 is provided with two second magnets 51 which are connected with the first magnets 22 on the magnetic socket 20 magnetically.

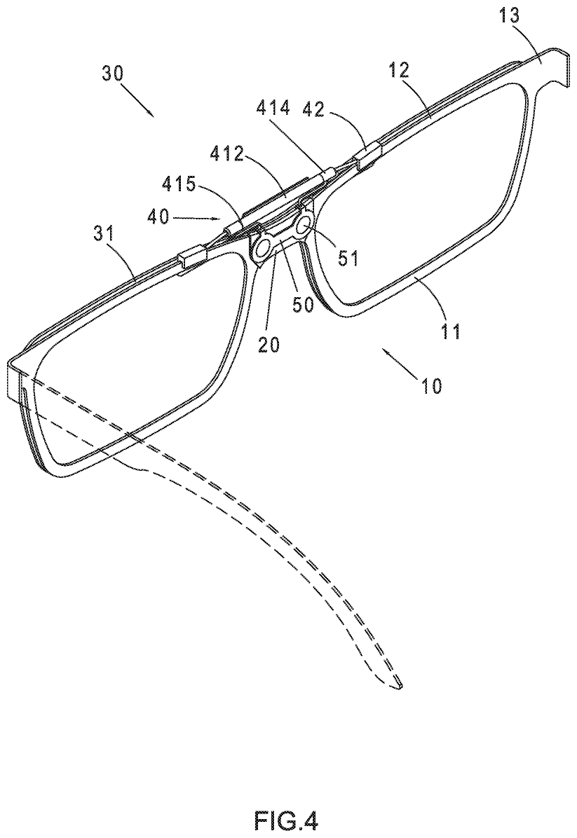

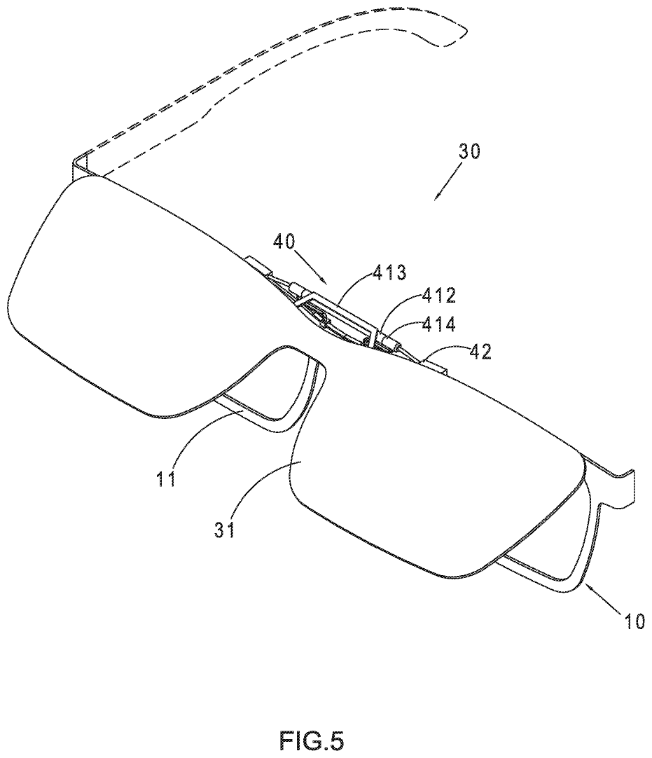

In practice, the front hanging eyeglasses 30 can be hung in the front of the spectacle frame 11 for supplementary functions of the auxiliary eyeglass 31 such as sunglasses, polarized lenses or reading glasses. Furthermore, the front hanging eyeglasses 30 can be securely connected with the pair of main eyeglasses 10 with the supporting portions 42 and the magnetic connector 50 engaged on the spectacle frame 11 and the magnetic socket 20, respectively. On the other hand, the auxiliary eyeglass 31 pivotally rotated about the shaft 411 of the support device 40 can be lifted upward and positioned at an angle of tilt as required with no need for supplementary functions of the auxiliary eyeglass 31 (FIG. 5). Furthermore, when the auxiliary eyeglass 31 is to be used, the auxiliary eyeglass 31 in FIG. 5 is pivoted downward and positioned in the front of the pair of main eyeglasses 30 (FIG. 4). Accordingly, a relative position between the auxiliary eyeglass 31 and the pair of main eyeglasses 10 is flexibly changed or adjusted as required for supplementary functions of the auxiliary eyeglass 31 but no need to remove the front hanging eyeglasses 30 which is not used.

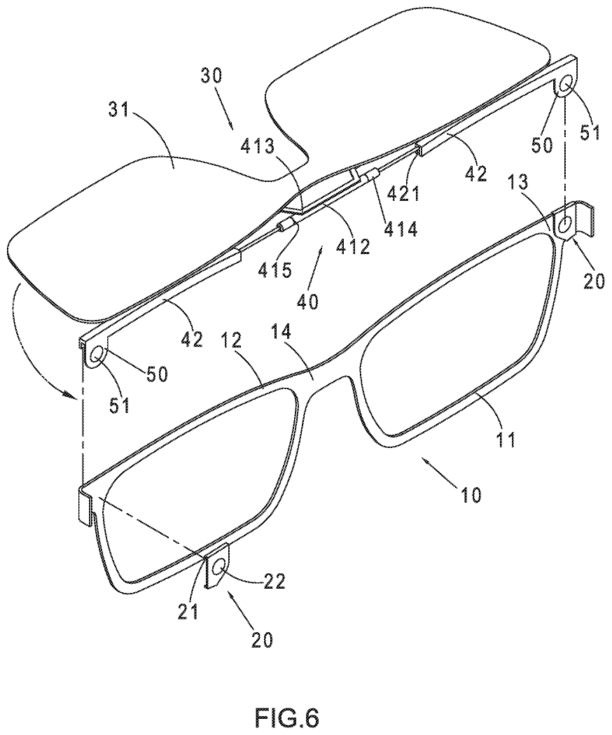

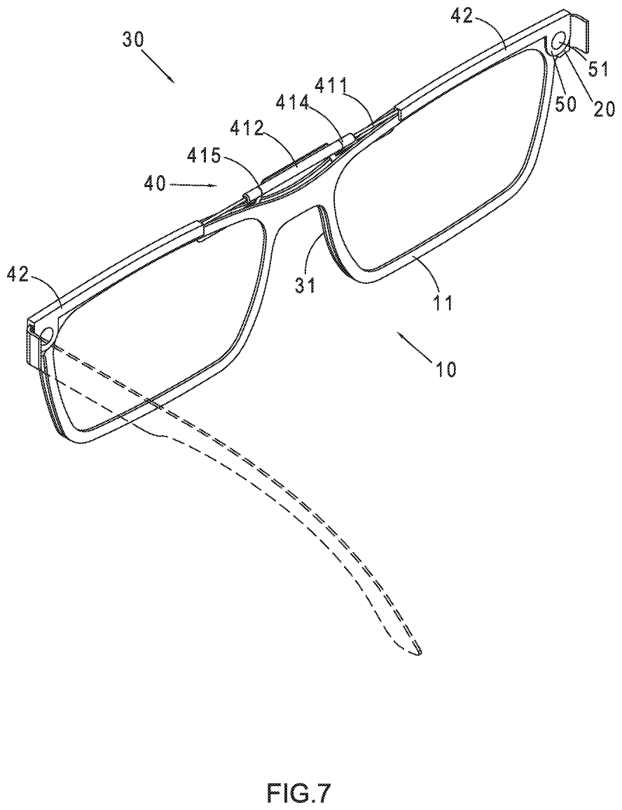

FIGS. 6 and 7 illustrate an attachment structure for front hanging eyeglasses in a second embodiment. In this embodiment, the attachment structure of the present invention includes two magnetic sockets 20 and two magnetic connectors 50. Each magnetic socket 20 is detachably combined on one of the two lateral edges 13 of the upper portion 12 of the spectacle frame 11, and the magnetic connectors 50 are formed at outer ends of the two supporting portions 42, respectively. When the supporting portions 42 are mounted on the spectacle frame 11, the magnetic connectors 50 are opposite to the magnetic sockets 20, respectively. Moreover, each magnetic connector 50 includes a second magnet 51 with which the first magnet 22 at a corresponding magnetic socket 20 is combined.

The front hanging eyeglasses 30 of the present invention relying on magnets 22, 51 and the supporting portions 42 is hung on the pair of main eyeglasses 10 easily, so that the pair of main eyeglasses 10 is supplemented by the front hanging eyeglasses 30 with other functions. Furthermore, an angle of tilt for the auxiliary eyeglass 31 relative to the main eyeglasses 10 is flexibly and conveniently changed as required.

The scope of the invention is to be indicated by the appended claims, rather than by the foregoing description, and all changes which come within the meaning and range of equivalency of the claims are intended to be embraced therein.

1. An attachment structure for front hanging eyeglasses, comprising:
a pair of main eyeglasses including a spectacle frame;
at least one magnetic socket mounted on the spectacle frame and provided with at least one first magnet; and
a pair of front hanging eyeglasses including an auxiliary eyeglass, a support device, and at least one magnetic connector, with the support device including two supporting portions, a shaft connected between the two supporting portions, and a rotary tube rotatably mounted around the shaft and engaged with the auxiliary eyeglass, with the two supporting portions combined on the spectacle frame, with the at least one magnetic connector combined with the support device and provided with at least one second magnet which connects with the at least one first magnet magnetically, wherein the auxiliary eyeglass is pivotally rotated about the shaft of the support device.

2. The attachment structure for front hanging eyeglasses as claimed in claim 1, wherein the shaft has at least one positioning portion provided with a plurality of first teeth, with at least one longitudinal end of the rotary tube provided with a plurality of second teeth engaged with the plurality of first teeth, wherein the auxiliary eyeglass can be positioned at multiple locations by the combination of the first and second teeth when rotating about the shaft of the support device.

3. The attachment structure for front hanging eyeglasses as claimed in claim 1, wherein the spectacle frame includes an upper portion having a bridge at the center thereof, with a top of the magnetic socket provided with a snap-fit portion which is detachably combined on the bridge of the spectacle frame.

4. The attachment structure for front hanging eyeglasses as claimed in claim 3, wherein the shaft is provided with two spaced positioning portions, with the rotary tube located between the two positioning portions, with two spaced connection pins provided on the at least one magnetic connector and respectively connected to the two positioning portions.

5. The attachment structure for front hanging eyeglasses as claimed in claim 1, wherein the spectacle frame includes an upper portion having two lateral edges, with the at least one magnetic socket including two magnetic sockets, with a top of each of the two magnetic sockets provided with a snap-fit portion which is detachably combined on one of the two lateral edges of the spectacle frame, with the at least one magnetic connector including two magnetic connectors which are formed at outer ends of the two supporting portions, respectively.

6. The attachment structure for front hanging eyeglasses as claimed in claim 1, wherein the spectacle frame includes an upper portion, and a connecting slot is provided in a bottom of each supporting portion for combining on the upper portion of the spectacle frame.
